(19) United States
(12) Patent Application Publication
(10) Pub. No.: US 2019/0311449 A1
(43) Pub. Date: Oct. 10, 2019

(54) METHOD AND SYSTEM FOR GENERATING AND MONITORING TRAINING MODULES

(71) Applicant: Sam Caucci, Newark, NJ (US)

(72) Inventor: Sam Caucci, Newark, NJ (US)

(21) Appl. No.: 15/949,964

(22) Filed: Apr. 10, 2018

(51) Int. Cl. G06Q 50/20; G06Q 10/10; G09B 5/06; G09B 7/04; G09B 7/08; A63F 13/85

(52) U.S. Cl. CPC G06Q 50/2057; G06Q 10/101; A63F 13/85; G09B 7/04; G09B 7/08; G09B 5/065

(57) ABSTRACT

A method for compiling and presenting training materials to employees, the method comprising, receiving, by one or more processors, a request to compile a training module, analyzing, by one or more processors, a set of parameters of the request, wherein the set of parameters pertain to subject matter, compiling, by one or more processors, a quantity of pre-existing training materials, parsing, by one or more processors, the quantity of pre-existing training materials associated with the request to determine if a first portion of the quantity of pre-existing training materials are related to the request, accessing, by one or more processors, a template for the request, wherein the template is based on a specific format of the training module, integrating, by one or more processors, the first portion of the quantity of pre-existing training materials into the template, and generating, by one or more processors, the training module.

### BACKGROUND

This disclosure relates generally to a system and method for training and evaluating personnel within an organization. More specifically to a method, computer program and computer system for allowing for efficient methods to generate training and evaluation materials through a process of integrating existing training materials and creating a gamified training process for personnel

In today's age of quality management, global competition, and rapidly-changing technology, employers and organizations are in constant need of novel and improved methods for training and evaluating their employees and personnel. One important characteristic for successful and effective training models is the ability to inspire the employees or users to participate in regular training activities in order to continuously advance their knowledge and skills and/or to become certified in various fields. Another important feature that facilitates effective training is the extent to which such methods promote collaboration amongst the employees or users.

To encourage employee participation, employers frequently need to offer a reward to an employee who gets trained, advances, and/or becomes certified in a particular area or for a particular cause. This is especially true given that employees are generally required to devote additional time outside of their standard work day in order to participate in training and educational activities. As a result, employers often find it challenging to motivate employees to give up part of their “free time” without offering financial or other types of incentives in exchange for performing such activities. Accordingly, this current form of training results in significant costs to employers, such as the fees associated with paying consultants, loss of employee work-hours and incentivizing employee participation in training activities.

In addition to encouraging employees to participate in additional training and continuous training programs. There is the need for manager or personnel to create these training modules or systems. The manager is spending a large amount of time reviewing materials, coming up with manuals, formulating training sessions, holding the training sessions, and spending a large amount of time preparing the materials. Accordingly, it is desired for the manager to be able to create training programs and modules for their employees was ease, efficiently, and a high level of engagement.

The need for novel approaches to training and evaluating employees and other personnel is particularly important in certain companies, such as sales organizations, retail, hospitality, financial services, educations, and almost every other industry where there has typically been no meaningful incorporation of any formal training procedures. Therefore, a need for a computer-based system for training and evaluating users, such as employees or other individuals associated with an organization. There is also a need for such a system that provides users with training and collaborative activities through an enhanced, user-friendly training platform.

### SUMMARY

In a first embodiment, the present invention is a method for compiling and presenting training materials to employees, the method comprising; receiving, by one or more processors, a request to compile a training module, analyzing, by one or more processors, a set of parameters of the request, wherein the set of parameters pertain to subject matter, compiling, by one or more processors, a quantity of pre-existing training materials;, parsing, by one or more processors, the quantity of pre-existing training materials associated with the request to determine if a first portion of the quantity of pre-existing training materials are related to the request, accessing, by one or more processors, a template for the request, wherein the template is based on a specific format of the training module, integrating, by one or more processors, the first portion of the quantity of pre-existing training materials into the template, and generating, by one or more processors, the training module.

In a second embodiment, the present invention is a computer program product for compiling and presenting training materials to employees, the method comprising: one or more computer readable storage media and program instructions stored on the one or more computer readable storage media, the program instructions comprising; program instructions to receive a request to compile a training module, program instructions to analyze a set of parameters of the request, program instructions to compile a quantity of pre-existing training materials, program instructions to parse the quantity of pre-existing training materials associated with the request to determine if a first portion of the quantity of pre-existing training materials are related to the request, program instructions to access a template for the request, wherein the template is based on the set of parameters, program instructions to integrate the portion of the quantity of pre-existing training materials into the template, and program instructions to generate the training module.

In a third embodiment, the present invention is a computer system for compiling and presenting training materials to employees, the method comprising; one or more computer processors, one or more computer readable storage media, and program instructions stored on the one or more computer readable storage media for execution by, at least one of the one or more processors, the program instructions comprising; program instructions to receive a request to compile a training module, program instructions to analyze a set of parameters of the request, program instructions to compile a quantity of pre-existing training materials, program instructions to parse the quantity of pre-existing training materials associated with the request to determine if a first portion of the quantity of pre-existing training materials are related to the request, program instructions to access a template for the request, wherein the template is based on the set of parameters, program instructions to integrate the portion of the quantity of pre-existing training materials into the template, and program instructions to generate the training module.

### BRIEF DESCRIPTION OF THE DRAWINGS

FIG. 1 depicts a block diagram depicting a computing environment, in accordance with one embodiment of the present invention.

FIG. 2 depicts a flowchart of the operational steps taken by the generation function within the computing environment of FIG. 1, in accordance with an embodiment of the present invention.

FIG. 3 depicts a flowchart of the operational steps taken by the generation function within the computing environment of FIG. 1, in accordance with an embodiment of the present invention.

FIG. 4 depicts a flowchart of the operational steps taken by the result function within the computing environment of FIG. 1, in accordance with an embodiment of the present invention.

FIG. 5 depicts a block diagram depicting the internal and external components of the server of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

As discussed above, employee and organizations often have a difficult time motivating their employee associated with the organization to participate in training activities and collaborate with and assist another employee. This is especially true for certain industries or for certain types of organizations in which the participation in any kind of formal training and collaboration process have been disfavored due to the more interactive personalities of their current employee. To encourage regular participation in training and collaboration by such employee, the system and method provided herein that allow employee to access a more enjoyable training system and allow the training material creator a more streamlined and user- friendly method of creating the training materials.

Embodiments of the present invention discloses generating training materials based on existing training materials, that are presented to the employee in a more user friend format and presentation, while allowing the creator the training materials a simplified method of generating the training materials and allowing efficient updating and modification of the training materials to stay as up-to-date as possible.

The present invention will now be described in detail with reference to the Figures.

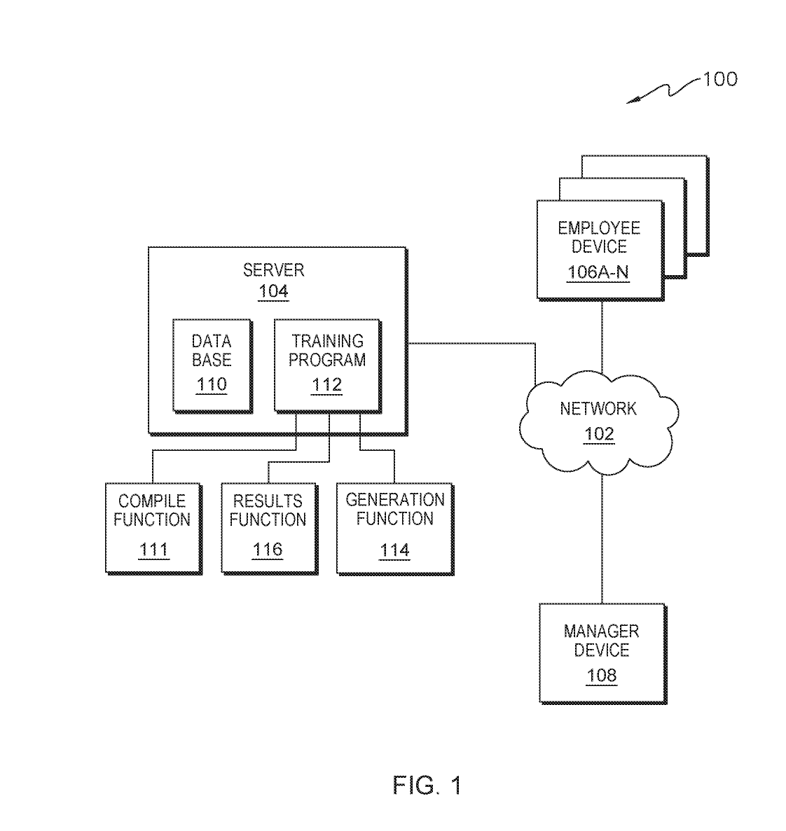

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, server 104, employee computing devices 106A-N, and manager computing device 108. Computing environment 100 may include additional servers, computers, or other devices not shown.

Network 102 may be a local area network (LAN), a wide area network (WAN) such as the Internet, any combination thereof, or any combination of connections and protocols that can support communications between server 104, employee computing devices 106A-N, and manager computing device 108, in accordance with embodiments of the invention. Network 102 may include wired, wireless, fiber optic connections, or cloud-based computing environment.

In cloud-based computing environment, there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

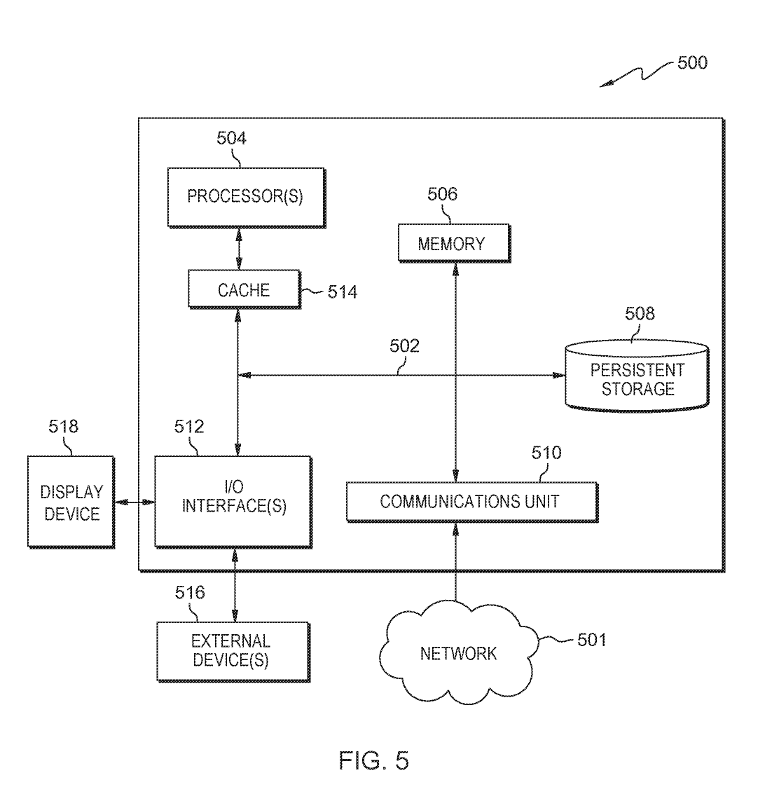

Server 104 may be a management server, a web server, or any other electronic device or computing system capable of processing program instructions and receiving and sending data. In some embodiments, server 104 may be a laptop computer, tablet computer, netbook computer, personal computer (PC), a desktop computer, or any programmable electronic device capable of communicating via network 102. In one embodiment, server 104 may be a server computing system utilizing multiple computers as a server system, such as in a cloud computing environment. In one embodiment, server 104 represents a computing system utilizing clustered computers and components to act as a single pool of seamless resources. In the depicted embodiment database 110 and training program 112 are located on server 104. Server 104 may include components, as depicted and described in further detail with respect to FIG. 5.

Employee computing device 106A-N may be a management server, a web server, or any other electronic device or computing system capable of processing program instructions and receiving and sending data. In some embodiments, Employee computing device 106A-N may be a laptop computer, tablet computer, netbook computer, personal computer (PC), a desktop computer, or any programmable electronic device capable of communicating with server 104 and manager computing device 108 via network 102. In other embodiments, Employee computing device 106A-N may represent a server computing system utilizing multiple computers as a server system, such as in a cloud computing environment. In the depicted embodiment, employee computing device 106A-N represents a plurality of employee computing devices. In other embodiments, Employee computing device 106A-N may represent a single computing device. In additional embodiments, employee computing device 106A-N may contain training program 112, generation function 114, result function 116, database 110, or a combination there of. Employee computing device 106A-N may include components, as depicted and described in further detail with respect to FIG. 5.

Manager computing device 108 may be a management server, a web server, or any other electronic device or computing system capable of processing program instructions and receiving and sending data. In some embodiments, Manager computing device 108 may be a laptop computer, tablet computer, netbook computer, personal computer (PC), a desktop computer, or any programmable electronic device capable of communicating with server 104 and employee computing device 106A-N via network 102. In other embodiments, Manager computing device 108 may represent a server computing system utilizing multiple computers as a server system, such as in a cloud computing environment. In additional embodiments, Manager computing device 108 may contain training program 112, generation function 114, result function 116, database 110, or a combination there of. Manager computing device 108 may include components, as depicted and described in further detail with respect to FIG. 5.

Database 110 may be a repository that may be written to and/or read by training program 112, generation function 114, result function 116, or a combination thereof. Information created, or gathered from training program 112, generation function 114, result function 116, or a combination thereof may be stored to database 110. Such information may include training materials, modules, scores, results, or the like. In one embodiment, database 110 is a database management system (DBMS) used to allow the definition, creation, querying, update, and administration of a database(s). In the depicted embodiment, database 110 resides on server 104. In other embodiments, database 110 resides on another server, or another computing device on network 102.

Training program 112 generates the gaming modules for the employee from the training materials, distribute these gaming modules to the employee, retain results of the employee's performance, and present the results to the managers. In the depicted embodiment, training program 110 utilizes network 102 to communicate with manager device 108 and the employee device 106A-N. In the depicted embodiment, training program 112 resides on server 104. In one embodiment, training program 112 resides on various computing devices connected to network 102 and is able to communicate with the databases and computing devices connected to the network 102.

Generation function 114 operates to parse the training materials, extract desired content, receive a request to create a gaming module, input the extracted content, and create the gaming module. In the depicted embodiment, generation function 114 is a function of training program 112. In other embodiments, generation function 114 may be a stand-alone program located on a server, or computing device, provided generation function 114 has access to result function 116 and database 110.

Result function 116 operates to receive results of an employee performance of at least one gaming module, compile the results, compare the results against other employee, and present the desired results to the requesting person. In the depicted embodiment, result function 116 is a function of training program 112. In other embodiments, result function 116 may be a stand-alone program located on a server, or computing device, provided result function 116 has access to generation function 114 and database 110.

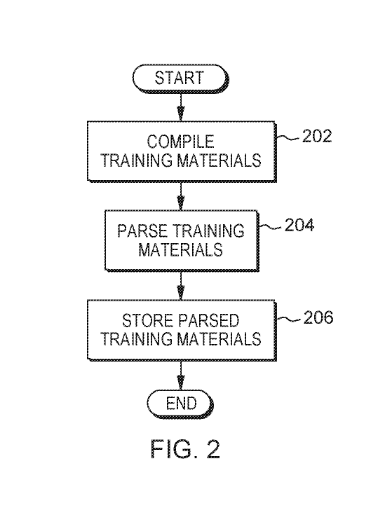

FIG. 2 depicts a flowchart of the operational steps taken by the generation function 114 within the computing environment of FIG. 1, in accordance with an embodiment of the present invention. The process(es) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 202, compile function 111 compiles training materials. Compile function 111 compiles a plurality of documents associated with the entity in which the training program 112 is associated with. Through the compiling all training materials, training sessions, presentations, and other materials in both text, images, videos, audio and the like are compiled by compile function 111 and stored in database 110 or the like. In some embodiments, compile function 111 compiles additional materials associated with the entity to provide a further enhanced set of materials to reference for the gaming module creation. In additional embodiments, compile function 111 may compile, local, state, federal, or other governmental statutory requirements to again, further enhance the gaming modules and to assist in conforming to all required regulation. For example, if employees need to complete a predetermined number of hours of training to maintain their license, this information is stored to assist the creation of the gaming modules and settings to adhere to this requirement.

In step 204, compile function 111 parses the training materials. Compile function 111 parses the compiled training materials to remove unnecessary, duplicate, irrelevant, or outdated materials. In some embodiments, the compile function 111 parses the training materials and formats the parsed materials to be easily transferred or inserted into the gaming module generation. The compile function 111 is able to analyzes these materials, decipher content which may be used in the gaming modules. The advantage of this is the ability to take existing training materials and reuse the content instead of needing to start anew.

In step 206, compile function 111 stores the parsed training materials. The stored parsed training materials may be stored in a variety of formats, categories, or structures. The parsed training materials are stored in a way, that they are easily integrated into a gaming module when necessary. The parsed training materials are stored in at least one format, for example when the questions for the gaming module are generated, there are numerous type of questions in which the parsed content can be integrated into, each having a different format and structure.

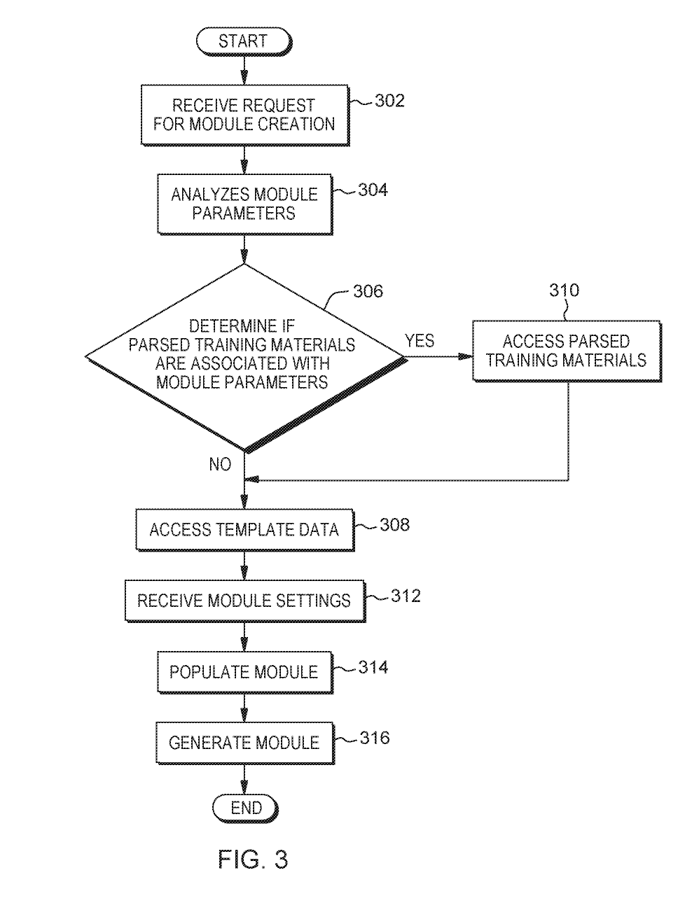

FIG. 3 depicts a flowchart of the operational steps taken by the generation function 114 within the computing environment of FIG. 1, in accordance with an embodiment of the present invention. The process(es) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 302, generation function 114 receives a request to create a gaming module. The gaming module is the interactive training gaming module created. The request may come from a manager, personnel, or third party. In some embodiments, the request is automatically generated when a predetermined requirement is achieved. In some embodiments, the request is accompanied by a predetermined set of data related to the purpose of the gaming module. For example, safety training, team building, sale techniques, etc.

In step 304, generation function 114 analyzes the gaming module parameters. The gaming module parameters are topics, subjects, content, or other relevant data associated with the gaming module object or purpose. These parameters may come from the request through input fields or may come from the requestor directly. Generation function 114 analyzes these parameters to determine if existing content related to the parameters was previously parsed and stored. The generation function 114 used predictive learning to locate relevant materials. In some embodiments, the parameters are categories. The categories are the topics, materials, content, or information which is to be covered within the gaming module. In some embodiments, the generation function 114 provides the creator with a plurality of categories to choose from. In another embodiment, generation function 114 provides the creator with a plurality of categories based on the parsed training materials. In other embodiments, generation function 114 provides predetermined categories to be covered based on previously generated gaming modules. In additional embodiments, the generation function 114 provides the creator with specific categories based on the creator's company information. For example, a sports team franchise would be presented with categories associated with the specific sport and team, versus an accounting company which would be presented in topics associated with accounting regulations and requirements.

In some embodiments, the generation function 114 is able to reference local, state, and federal regulations based on the parameters to compile information or requirements that may affect the gaming module settings.

In decision 306, generation function 114 determines if parsed training materials are associated with the gaming module parameters. The generation function 114 searches the stored location of the parsed training materials to determine if any of the materials are associated or related to the gaming module parameters. If generation function 114 determines that a predetermined quantity of the parsed training materials is associated with the gaming module parameters (YES branch, proceed to step 310) the parsed training materials are accessed. If generation function 114 determines that no parsed training materials are associated with the gaming module parameters (NO branch, proceed to step 308) the template data is accessed.

In step 308, generation function 114 accesses the template data. The template data is the data stored which is used to construct the gaming modules. This includes, but not limited to, the gaming module type, question types, the question structure, the gaming module settings, and the like. The gaming module type is either single player or multiplayer. The question types, may be, but are not limited to two answer questions, short answer, four answer questions, and role play. Wherein different types of question types are associated with single player or multiplayer gaming module types. Question structure is based on the question type to determine how the question and answers are presented to the employee.

In step 310, generation function 114 accesses the relevant parsed training materials. This access allows the generation function 114 to use this material when auto populating the gaming module. This is the advantage of the current method, wherein the auto populating of the gaming module has relevant material inserted into the questions based on a plurality of factors.

In step 312, generation function 114 receives the gaming module settings. The gaming module settings are used to establish the many features and function of the gaming module. One setting is the gaming module type. The type of the gaming module through either a single player mode or a multi-player mode. The single player mode is designed to allow for one person to interact with the gaming module to test their knowledge and intelligence about the content. The multi-player mode allows for a plurality of interactive designs for the employee to play together against the gaming module, in teams against each other, or other multi-person structures to allow for a more interactive training experience. The creator is provided with the various types to choose from as this directs the remainder of the generation process. A second setting is the question type. The generation function 114 based on the gaming module type preselected approved question types to be used. For example, the single player version may only allow for two answers and four answer questions, while multiplayer version may allow for two answers, four answer, short answer, and role play questions to be used within the gaming module. Other settings may include, the time frame for the gaming module to be active, time limits per question, maximum number of attempts, minimum scores required, randomization of both the question order as well as the answer order, and the like. In some embodiments, the settings include the color of the user interface, the audio or visual effects of right or wrong answers. In some instances, the score is adjusted based on a predetermined weight of each question. In other instances, the gaming module settings can allow for randomized weight associated with each question.

In yet additional embodiments, the generation function 114 provides gaming module settings based on the creator and the parsed training materials. For example, a business with five previously created gaming modules, automatically populates the gaming module settings based on the previously created gaming module settings.

The generation function 114 receives preferences associated with the user interface. The generation function 114 is able to customize the user interface based on a predetermined set of features and styles. These visual aspects are designed to provide a clean, user friendly, and attractive design to keep the employee interested in the content and the gaming module. Once created, the creator may adjust various features of the interface, such as color, positioning, image size, hyperlinks, and the like. For example, a sports franchise may want the color scheme to be that of the franchise.

In step 314, the generation function 114 populates the gaming module. Once the gaming module settings have been established, the generation function 114 builds the predetermined set of questions. The generation function 114 populates the questions based on the available parsed training materials and the gaming module settings. In some instances, the entirety of the questions is populated with questions and answers. In additional instances, a plurality of the questions and answers are populated, and the remainder is populated by the creator. In some embodiments, the generation function 114 populates a portion of the questions and answers and based on the analyzes of the gaming module parameters populates the remaining questions and/or answers with content which is determined to be relevant, appropriate, and contiguous with the question or answers. For example, if a question is about a sports franchise and three answers are player's names gathered from the parsed training materials, the generation function 114 locates an additional players name from the franchise and inserts that name into the answers. Generation function 114 used a form of cognitive computing or crawlers to determine the context of the question, locate at least one potential answer or question, and analyze if it is both appropriate and relevant to input. The advantage of this is to present the creator with a honed and specific set of questions and answers which require minimal editing if any. Thereby reducing the time spent creating a training manual from nothing, and also presenting the content to the employee in an attractive format.

In some embodiments, the generation function 114 is able to integrate audio, images, and videos into the questions either from the parsed training materials or from an ancillary database or the network. In some embodiments, the generation function 114 is able to create questions based on the content of these non-text parsed training materials through. For instance, through facial recognition technology, the generation function 114 may be able to identify a person in a photo and direct a question as to the name of that person. In additional embodiments, the generation function 114 may create questions that require the creator's input on audio, images, or videos.

In step 316, generation function 114 generates the gaming module. The gaming module is ready to be used by the employee. In some embodiments, the creator is able to return and edit material or content with the gaming module.

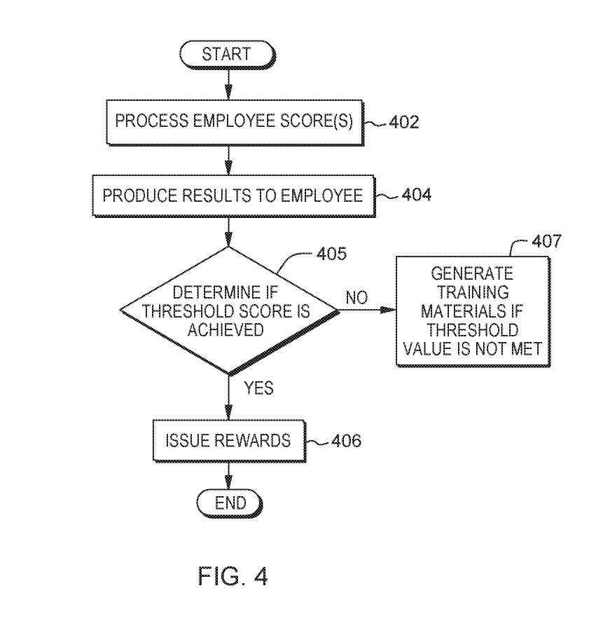

FIG. 4 depicts a flowchart of the operational steps taken by the result function 116 within the computing environment of FIG. 1, in accordance with an embodiment of the present invention. The process(es) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 402, result function 116 receives completion of a gaming module. The completion of the gaming module allows for the results function 116 to determine the score.

In step 404, result function 116 processes the score(s). Results function 116 calculates the score of the gaming module for the employee based on the gaming module settings. The calculated score may be presented to the employee, the creator, and other predetermined parties. The processing of the score may result in the employee being provided with additional information, such as, their answer to each question and the correct answer, additional information to review before future attempts, or other data associated with the employee and the gaming module. This may include the employee's historic data of the gaming module in question and additional gaming modules. Based on the employee's results, the result function 116 may generate training material for the employee based on their results and past performance. In additional embodiments, the results function 116 may locate previously created or stored training materials that match areas where the employee needs improvement. In some embodiments, the score is stored in a database. The score may be processed to the employee or to the creator. Wherein the creator has the ability to review the processed score as well as all other processed scores within the database. The scores may be sorted by various characteristics. The employee has the ability to view the score, their responses, the correct answers, any rewards, and the like associated with their data. The creator is able to further categorize the processed scores based on an individual, a team, a supervisor of the team, or a combination thereof. In one embodiment, the results function 116 may cause a notification (e.g. emails, newsletter, messages etc.) to one or more users with regards to ranking. In one example embodiment, the result function 116 may send a newsletter with ranking and scores of one or more users periodically, based on a pre-determined schedule, based on demands from one or more users, or a combination thereof.

In decision 405, result function 116 determines if a threshold score value is met. The threshold score value is used to establish a “passing” and “failing” score. If the result function 116 determines that the threshold score value is met, the result function 116 issues the rewards. If the result function 116 determines that the score has not been met or exceed. The result function 116 administers generates training materials for the user to improve their education on the topics (Step 408). In some embodiments, the training materials are related to areas which the user submitted incorrect answers.

In step 406, result function 116 issues a reward for the completed gaming module. In some embodiments, the result function 116 may motivate employee by offering rewards for completed milestones and important events. In one example embodiment, the result function 116 may reward employee with additional points for completing a gaming module more than the required amount or scoring above a predetermined value. In another embodiment, the result function 116 may create badges, leaderboards, or a combination thereof to motivate employee to continue their training activity. For example, the results function 116 may present all the employee scores to allow for a comparison against fellow employee. In some further embodiments, the result function 116 may allow employee to redeem their rewards for certain good and/or services. In some embodiments, the rewards the results of the gaming module and the correct answers.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

FIG. 5 depicts a block diagram 500 of components of a computing device, in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 500 is, in many respects, representative of the various computer subsystem(s) in the present invention. Accordingly, several portions of computing environment 500 will now be discussed in the following paragraphs.

Computing device 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any additional hardware components within a system. For example, communications fabric 502 can be implemented with one or more buses.

Computing device 500 is capable of communicating with other computer subsystems via network 501. Network 501 can be, for example, a local area network (LAN), a wide area network (WAN) such as the Internet, or a combination of the two, and can include wired, wireless, or fiber optic connections. In general, network 501 can be any combination of connections and protocols that will support communications between computing device 500 and other computing devices.

Memory 506 and persistent storage 508 are computer-readable storage media. In one embodiment, memory 506 includes random access memory (RAM) and cache memory 514. In general, memory 506 can include any suitable volatile or non-volatile computer-readable storage media.

Memory 506 is stored for execution by one or more of the respective computer processors 504 of computing device 500 via one or more memories of memory 506 of computing device 500. In the depicted embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in the examples, provides for communications with other data processing systems or devices, including computing device 500. In the examples, communications unit 510 includes one or more network interface cards. Communications unit 510 may provide communications through the use of either or both physical and wireless communications links.

I/O interface(s) 512 allows for input and output of data with other devices that may be connected to computing device 500. For example, I/O interface 512 may provide a connection to external devices 516 such as a keyboard, keypad, camera, a touch screen, and/or some other suitable input device. External devices 516 can also include portable computer- readable storage media such as, for example, thumb drives, portable optical or magnetic disks, and memory cards. Software and data used to practice embodiments of the present invention, e.g., regulation program 420 can be stored on such portable computer-readable storage media and can be loaded onto persistent storage 508 of computing device 500 via I/O interface(s) 512 of computing device 500. Software and data used to practice embodiments of the present invention, e.g., regulation program 420 can be stored on such portable computer-readable storage media and can be loaded onto persistent storage 508 of computing device 500 via I/O interface(s) 512 of computing device 500. I/O interface(s) 512 also connect to a display 518.

Display 518 provides a mechanism to display data to a patient and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state- setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the patient's computer, partly on the patient's computer, as a stand-alone software package, partly on the patient's computer and partly on a remote computer or entirely on the remote computer or server. In the latter scenario, the remote computer may be connected to the patient's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a gaming module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A method for compiling and presenting training materials to employees, the method comprising:
receiving, by one or more processors, a request to compile a training module;
analyzing, by one or more processors, a set of parameters of the request, wherein the set of parameters pertain to subject matter;
compiling, by one or more processors, a quantity of pre-existing training materials;
parsing, by one or more processors, the quantity of pre-existing training materials associated with the request to determine if a first portion of the quantity of pre-existing training materials are related to the request;
accessing, by one or more processors, a template for the request, wherein the template is based on a specific format of the training module;
integrating, by one or more processors, the first portion of the quantity of pre-existing training materials into the template; and
generating, by one or more processors, the training module.

2. The method of claim 1, wherein the pre-existing training materials consist of known training manuals.

3. The method of claim 1, wherein, the pre-existing training materials are compiled based on their association with the set of parameters of the request.

4. The method of claim 1, further comprising, building, by one or more processors, a template for the request based on the set of parameters.

5. The method of claim 1, further comprising, scoring, by one or more processors, responses received of the training module.

6. The method of claim 6, wherein the score is compared, by one or more processors, to a threshold score and if it is determined that the score is below a threshold score, providing, by one or more processors a set of training materials.

7. The method of claim 7, wherein a portion of the training materials may be the pre-existing training materials.

8. A computer program product for compiling and presenting training materials to employees, the method comprising:
one or more computer readable storage media and program instructions stored on the one or more computer readable storage media, the program instructions comprising:
program instructions to receive a request to compile a training module;
program instructions to analyze a set of parameters of the request;
program instructions to compile a quantity of pre-existing training materials;
program instructions to parse the quantity of pre-existing training materials associated with the request to determine if a first portion of the quantity of pre-existing training materials are related to the request;
program instructions to access a template for the request, wherein the template is based on the set of parameters;
program instructions to integrate the portion of the quantity of pre-existing training materials into the template; and
program instructions to generate the training module.

9. The computer program product of claim 8, wherein the set of parameters of the request are related to the type of training module to be created.

10. The computer program product of claim 8, wherein, the pre-existing training materials are compiled based on their association with the set of parameters of the request.

11. The computer program product of claim 8, further comprising, program instructions to build a template for the request based on the set of parameters.

12. The computer program product of claim 8, further comprising, program instructions to score responses received from the training module.

13. The computer program product of claim 12, wherein the score is compared, by one or more processors, to a threshold score and if it is determined that the score is below a threshold score, program instructions to provide a set of training materials.

14. The computer program product of claim 13, wherein a portion of the training materials may be the pre-existing training materials.

15. A computer system for compiling and presenting training materials to employees, the method comprising:
one or more computer processors, one or more computer readable storage media, and program instructions stored on the one or more computer readable storage media for execution by, at least one of the one or more processors, the program instructions comprising:
program instructions to receive a request to compile a training module;
program instructions to analyze a set of parameters of the request;
program instructions to compile a quantity of pre-existing training materials;
program instructions to parse the quantity of pre-existing training materials associated with the request to determine if a first portion of the quantity of pre-existing training materials are related to the request;
program instructions to access a template for the request, wherein the template is based on the set of parameters;
program instructions to integrate the portion of the quantity of pre-existing training materials into the template; and
program instructions to generate the training module.

16. The computer system of claim 15, wherein the set of parameters of the request are related to the type of training module to be created.

17. The computer system of claim 15, wherein, the pre-existing training materials are compiled based on their association with the set of parameters of the request.

18. The computer system of claim 15, further comprising, program instructions to build a template for the request based on the set of parameters.

19. The computer system of claim 15, further comprising, program instructions to score responses received from the training module.

20. The computer system of claim 19, wherein the score is compared, by one or more processors, to a threshold score and if it is determined that the score is below a threshold score, program instructions to provide a set of training materials.
